(19) United States
(12) Patent Application Publication
(10) Pub. No.: US 2016/0253210 A1
(43) Pub. Date: Sep. 1, 2016

(54) Cellular with Multi-Processors

(71) Applicants: Yi-Chuan CHENG, Changhua County (TW); Kuo-Ching CHIANG, New Taipei City (TW)

(72) Inventors: Yi-Chuan CHENG, Changhua County (TW); Kuo-Ching CHIANG, New Taipei City (TW)

(21) Appl. No.: 15/150,442

(22) Filed: May 10, 2016

Related U.S. Application Data
(63) Continuation-in-part of application No. 13/037,361, filed on Mar. 1, 2011.
Application No. 13/037,361 is a continuation-in-part of application No. 11/819,124, filed on Jun. 25, 2007, now abandoned.
Application No. 11/819,124 is a continuation-in-part of application No. 10/900,766, filed on Jul. 28, 2004, now Pat. No. 7,388,549.
Application No. 10/900,766 is a continuation-in-part of application No. 10/898,761, filed on Jul. 26, 2004, now abandoned.

(51) Int. Cl. G06F 9/50

(52) U.S. Cl. CPC G06F 9/505; G06F 9/5044

(57) ABSTRACT

The present invention discloses a cellular with multi-processors, comprising a memory, a central processing unit with a plural of processors coupled to the memory, and a task assigning unit coupled to said central processing unit, to assign task duties to at least one the plural of processors based on characteristics and workload of tasks. The assigned number of the plural of processors is more than a half of the plural of processors in relatively high workload of tasks. The assigned number of the plural of processors is less than a half of the plural of processors in relatively low workload of tasks.

### CROSS REFERENCE TO RELATED APPLICATIONS

This application is a continuation-in-part of Ser. No. 13/037,361, filed on Mar. 1, 2011, which is a continuation-in-part of Ser. No. 11/819,124, filed on Jun. 25, 2007, which is a continuation-in-part of Ser. No. 10/900,766, filed on Jul. 28, 2004, and of Ser. No. 10/898,761, filed on Jul. 26, 2004.

### TECHNICAL FIELD

The present invention relates a cellular, and more particularly, a cellular with multi-processors.

### BACKGROUND OF RELATED ARTS

Multiple processing units are able to process different computational instruction entities (such as threads, tasks, processes, applications, etc.) simultaneously. As such, multiple processing units can execute more instructions in a given period of time as compared to a single processing unit. In certain applications, a worst case or longest execution time for the executing instruction entities must be known for the different instruction entities that execute on each processor. The challenge of determining the worst case execution time due to resource conflicts inhibits certain systems from taking advantage of the full performance benefits presented by multi-processing unit processors, and also prevents them from being used in certain safety-critical environments such as those requiring a high degree of execution predictability.

A significant percentage of current multi-processor technology involves either single operating system (OS) symmetrical shared memory multi-processor (SMP) platforms, or distributed OS platforms. In the case of SMP, one operating system controls all the central processing units (CPUs) in the system. A distributed OS on the other hand allows multiple copies of the same operating system to run on multiple partitions of an MP platform. However, both SMP and distributed OS systems have limitations. For example, neither system allows for different, specialized operating systems (particularly suited to specific tasks) on different partitions. One operating system may be extremely effective for real-time processing tasks, while another operating system may merely be a glorified transmission control protocol/Internet protocol (TCP/IP) stack with firewall capabilities, and so on.

### SUMMARY

The present invention discloses a cellular with multi-processors, comprising a memory, a central processing unit with a plural of processors coupled to the memory. An efficiency manager module is configured to leverage a comparative analysis of one or more performance of the plural of processors to assign a workload to a certain processor which is best positioned to efficiently process the workload, wherein assigned number of the plural of processors is more than a half of the plural of processors in relatively high workload of tasks and assigned number of the plural of processors is less than a half of the plural of processors in relatively low workload of tasks. A task assigning unit is coupled to the central processing unit, to assign task duties to at least one the plural of processors based on characteristics and workload of tasks. The assigned number of the plural of processors is more than a half of the plural of processors in relatively high workload of tasks. The assigned number of the plural of processors is less than a half of the plural of processors in relatively low workload of tasks.

The efficiency manager module is coupled to the central processing unit and the task assigning unit.

The assigned number of the plural of processors is greater than 5, 6, 7, 8, 9 or 10. The plural of processors is using an identical clock in a synchronous system. A clock of each one of the plural of processors is uniquely associated with its corresponding clock generator in an asynchronous system.

### BRIEF DESCRIPTION OF THE DRAWINGS

FIG. 1 illustrates the scheme for due semiconductor processors system.

FIG. 2 illustrates a cellular with multi-processors of the present invention.

### DETAILED DESCRIPTION

Hereinafter, the present invention will be described in detail with reference to the accompanying drawings. In this case, a detailed description of an already known function and/or configuration will be skipped. In contents disclosed herein below, a part required for understanding an operation according to various exemplary embodiments will be described in priority and a description of elements which may obscure the spirit of the present invention will be skipped. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

The present invention proposes a cellular with multi-processors. In one embodiment, the heat pump device may be used for processor of computer, notebook or mobile device such as cellular, PDA, GPS. In one case, pluralities of heat pump device are formed on the outside of chip having conductive balls. The flip-chip package is used for illustration only, not limits the scope of the present invention. The chip could be any device such as LED. At least one heat pump device is formed on the semiconductor chip package. Most of the thermal is generated by the chip or processor of the computer, notebook or mobile device. In order to improve the performance of thermal dissipation, a heat sink may be attached on the heat pump device by adhesion or thermal conductive glue. Accordingly, the heat sink is formed on the hot side of the device.

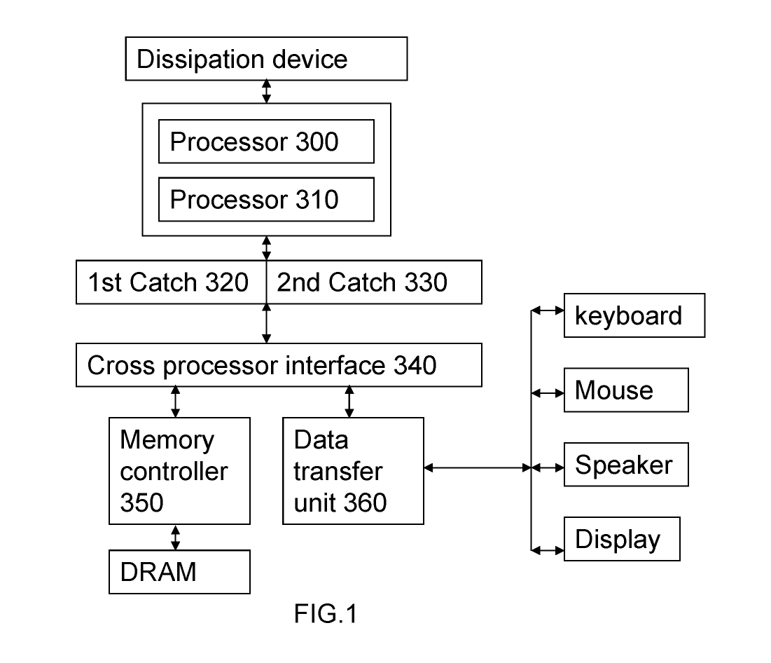

Please refer to FIG. 1, the electronic system includes a first processor 300 and a second processor 310. A first catch 320 and a second catch 330 are coupled to the first processor 300 and a second processor 310, respectively. A cross processor data transfer interface 340 is coupled to the first catch 320 and a second catch 330. A memory controller 350 and a data transfer unit 360 are coupled to the cross processor data transfer interface 340. The cross processor data transfer interface 340 is used to determine how to transfer the date in/out to/from the first processor 300 and a second processor 310. The DRAM is coupled to the memory controller 350. A plurality of periphery devices (such as Mic, speaker, keyboard, mouse) are coupled to the data transfer unit 360. A fan may be optionally coupled to the heat dissipation device. If the system is single chip system, the cross-process interface is omitted. If the system is communication device, RF is necessary. Therefore, the present invention discloses a thermal solution for a computer system including a heat dissipater mentioned above coupled to the CPU to dissipate the thermal generated by the CPU.

In the present invention, the “cross-processor data transfer interface” 340 is provide to couple to the first cache 320 and the second cache 330, and the function of the “cross-processor data transfer interface” 340 is defined to determine how to transfer data via the first processor 300 and the second processor 310, and to assign task duties to first processor 300 or second processor 310; i.e. the “cross-processor data transfer interface” 340 is crossing to the first processor 300 and the second processor 310, and thus (i) the “cross-processor data transfer interface” 340 can make the first processor 300 and the second processor 310 simultaneously or parallelly operating due to the function of crossing, and (ii) the “cross-processor data transfer interface” 340 can assign tasks to the first processor 300 or the second processor 310 due to the function of crossing.

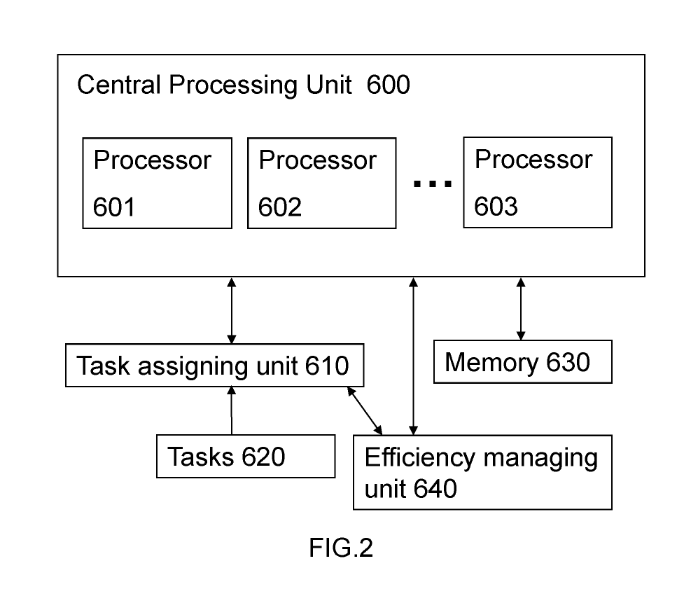

The invention further provides a cellular with a central processing unit (CPU) 600 having multiple individual cores or processors (processing components) 601, 602, 603 shown in FIG. 2, each of which may or may not comprise multiple cores and/or sub-cores. The CPU 600 may comprise a first core 601, a second core 602 . . . and a Nth core 603 as understood by one of ordinary skill in the art. Further, instead of a CPU 600, a digital signal processor (“DSP”) may also be employed as understood by one of ordinary skill in the art. Moreover, each of the cores 601, 602, 603 may process workloads at similar, identical or different efficiencies under similar, identical or different operating conditions.

As illustrated in FIG. 2, the CPU or digital signal processor 600 is coupled to the memory 630, for example via a bus. The efficiency managing unit 640 is coupled to the CPU 600 and the task assigning unit 610. The task assigning unit 610 is coupled to the CPU 600. The CPU 600, as noted above, is a multiple-core processors having N (integer) core processors. That is, the CPU 600 includes a first core 601, a second core 602 . . . and a N-th core 603. As is known to one of ordinary skill in the art, each of the first core 601, the second core 602 . . . and the N-th core 603 is available for supporting a dedicated application or program, and may provide differing levels of performance under similar, identical or different operating conditions. Alternatively, one or more applications or programs can be distributed for processing across two or more of the available cores.

An exemplary efficiency managing unit 640 is configured to leverage a comparative analysis of one or more performance of the processors 601, 602 . . . 603 to instruct the task assigning unit 610 to assign a workload to a certain processor which is best positioned to efficiently process the workload. Notably, at different times, the task assigning unit 610 may select different processors 601, 602 . . . 603 for application based-on task efficiency aware management policies. In this way, it is an advantage of certain embodiments that an task assigning unit 610 optimizes quality of service when workload assignments are assigned to the most efficient processors 601, 602 . . . 603 to handle the active workload, and thereby reducing the power consumption by the most efficient processor(s) to extend battery life of the cellular. It should be noted that the efficiency managing unit 640 and the task assigning unit 610 may be separated unit, or can be integrated into one unit. Both of the units maybe a hardware, software or firmware.

The efficiency managing unit 640 may determine to reduce clock generator frequency to the less efficient core(s) in an asynchronous system or in a synchronous system, the efficiency managing unit 640 may cause workloads to be reallocated from a less efficient core to a more efficient core or queued workloads to be scheduled to more efficient cores. In an asynchronous system, clock of each core is uniquely associated with its corresponding clock generator of said core. In a synchronous system, clock of all cores is using an identical clock. The dynamic control and voltage scaling adjustment policies dictated by the efficiency managing unit 640 may set processor clock speeds at reduced levels on less efficient processing components, transition power states of certain less efficient processors from active states to idle states, etc. In some embodiments, workload allocations and/or reallocations dictated by the efficiency managing unit 640 may be implemented.

According to type of files, the number of tasks, dedicated application or program, the task assigning unit 610 can decide which processor(s) to be selected for operating on the active workload, for example phone communication, Internet access, video streaming, photographing, text processing, monitoring, image recognition, key-word searching, control, web browsing, online social networking, microblogging service, online game, . . . etc. That is, based on the characteristics and workload of the tasks 620 to be processed, the selected number of the cores of the CPU 600 is determined by the task assigning unit 610, regardless of the thermal management or thermal condition(s). The assigned number of the plural of processors is more than a half of the plural of processors in relatively high workload of tasks. The assigned number of the plural of processors is less than a half of the plural of processors in relatively low workload of tasks.

For example, low-level tasks may utilize low-level processor(s) or fewer processor(s) for processing, and high-level tasks may utilize high-level processor(s) or more processor(s) for processing, to make effective use of the plural of processors. High-level and low-level are typically terms used to classify, describe and point to specific goals of a systematic operation, though its uses also vary depending on the context, such as use in computer science or cellular technology. In general, high-level is used to describe operations that are more abstract in nature, where overall goals and systemic features are typically more concerned with the wider, macro system as a whole. Alternatively, a low-level description is one that describes more specific individual components of a systematic operation, focusing on the details of rudimentary micro functions rather than macro, complex processes. Low-level classification is typically more concerned with individual components within the system and how they operate.

The first core 601, the second core 602 through to the Nth core 603 of the CPU 600 may be integrated on a single integrated circuit die, or they may be integrated or coupled on separate dies in a multiple-circuit package. Designers may couple the first core 601, the second core 602 through to the Nth core 603 via one or more shared caches and they may implement message or instruction passing via network topologies such as bus, ring, mesh and crossbar topologies.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A cellular with multi-processors, comprising:
a memory;
a central processing unit with a plural of processors coupled to said memory; and
an efficiency managing unit configured to leverage a comparative analysis of one or more performance of said plural of processors to assign a workload to a certain processor which is best positioned to efficiently process said workload, wherein assigned number of said plural of processors is more than a half of said plural of processors in relatively high workload of tasks and assigned number of said plural of processors is less than a half of said plural of processors in relatively low workload of tasks.

2. The cellular as claimed in claim 1, further comprising a task assigning unit coupled to said central processing unit, to assign task duties to at least one said plural of processors based on characteristics and workload of tasks.

3. The cellular as claimed in claim 1, wherein said assigned number of said plural of processors is greater than 5.

4. The cellular as claimed in claim 1, wherein said assigned number of said plural of processors is greater than 6.

5. The cellular as claimed in claim 1, wherein said assigned number of said plural of processors is greater than 7.

6. The cellular as claimed in claim 1, wherein said assigned number of said plural of processors is greater than 8.

7. The cellular as claimed in claim 1, wherein said assigned number of said plural of processors is greater than 9.

10. The cellular as claimed in claim 1, wherein said assigned number of said plural of processors is greater than 10.

11. The cellular as claimed in claim 1, wherein said plural of processors is using an identical clock.

12. The cellular as claimed in claim 1, wherein a clock of each one of said plural of processors is uniquely associated with its corresponding clock generator.

13. A cellular with multi-processors, comprising:
a memory;
a central processing unit with a plural of processors coupled to said memory; and
an efficiency managing unit configured to leverage a comparative analysis of one or more performance of said plural of processors to assign a workload to a certain processor which is best positioned to efficiently process said workload, wherein a first assigned number of said plural of processors for relatively high workload of tasks is more than a second assigned number of said plural of processors for relatively low workload of tasks,
a task assigning unit is coupled to said efficiency managing unit.

14. The cellular as claimed in claim 13, wherein said assigned number of said plural of processors is greater than 5, 6, 7, 8, 9 or 10.

15. The cellular as claimed in claim 13, wherein said plural of processors is using an identical clock.

16. The cellular as claimed in claim 13, wherein a clock of each one of said plural of processors is uniquely associated with its corresponding clock generator.

17. A cellular with multi-processors, comprising:
a memory;
a central processing unit with a plural of processors coupled to said memory; and
an efficiency managing unit configured to leverage a comparative analysis of one or more performance of said plural of processors to assign a workload to a certain processor which is best positioned to efficiently process said workload, wherein a first assigned number of said plural of processors for relatively high workload of tasks is more than a second assigned number of said plural of processors for relatively low workload of tasks, wherein a clock of each one of said plural of processors is uniquely associated with its corresponding clock generator.

18. The cellular as claimed in claim 17, wherein said assigned number of said plural of processors is greater than 5, 6, 7, 8, 9 or 10.

19. The cellular as claimed in claim 17, further comprising a task assigning unit coupled to said central processing unit, to assign task duties to at least one said plural of processors based on characteristics and workload of tasks.

20. The cellular as claimed in claim 19, wherein said task assigning unit is coupled to said efficiency managing unit.
